(19) United States
(12) Patent Application Publication
(10) Pub. No.: US 2003/0233232 A1
(43) Pub. Date: Dec. 18, 2003

(54) System and method for measuring domain independence of semantic classes

(75) Inventors: J. Eric Fosler-Lussier, Hillsborough, NJ (US); Chin-Hui Lee, Basking Ridge, NJ (US); Andrew N. Pargellis, Hoboken, NJ (US); Alexandros Potamianos, Westfield, NJ (US)

Correspondence Address: HITT GAINES P.C., P.O. BOX 832570, RICHARDSON, TX, 75083, US

(73) Assignee: Lucent Technologies Inc., Murray Hill, NJ

(21) Appl. No.: 10/171,256

(22) Filed: Jun. 12, 2002

(51) Int. Cl. G10L 15/00

(52) U.S. Cl. 704/251

(57) ABSTRACT

A system for, and method of, measuring a degree of independence of semantic classes in separate domains. In one embodiment, the system includes: (1) a cross-domain distance calculator that estimates a similarity between n-gram contexts for the semantic classes in each of the separate domains to determine domain-dependent relative entropies associated with the semantic classes and (2) a distance summer, associated with the cross-domain distance calculator, that adds the domain-dependent distances over a domain vocabulary to yield the degree of independence of the semantic classes.

### CROSS-REFERENCE TO RELATED APPLICATION

The present application is related to U.S. patent application Ser. No. ______, [ATTORNEY DOCKET NO. AMMICHT 6-1-3], entitled “System and Method for Representing and Resolving Ambiguity in Spoken Dialogue Systems,” commonly assigned with the present application and filed concurrently herewith.

### TECHNICAL FIELD OF THE INVENTION

The present invention is directed, in general, to speech understanding in spoken dialogue systems and, more specifically, to a system and method for measuring domain independence of semantic classes encountered by such spoken dialogue systems.

### BACKGROUND OF THE INVENTION

Despite the significant progress that has been made in the area of speech understanding for spoken dialogue systems, designating the understanding module for a new domain requires large amounts of development time and human expertise. (See, for example, D. Jurafsky et al., “Automatic Detection of Discourse Structure for Speech Recognition and Understanding,” Proc. IEEE Workshop on Speech Recog. And Underst., Santa Barbara, 1997, incorporated herein by reference). The design of speech understanding modules for a single domain (also referred to as a “task”) has been studied extensively. (See, S. Nakagawa, “Architecture and Evaluation for Spoken Dialogue Systems,” Proc. 1998 Intl. Symp. On Spoken Dialogue, pp. 1-8, Sydney, 1998; A. Pargellis, H. K. J. Kuo, C. H. Lee, “Automatic Dialogue Generator Creates User Defined Applications,” Proc. of the Sixth European Conf. on Speech Comm. and Tech., 3:1175-1178, Budapest, 1999; J. Chu-Carroll, B. Carpenter, “Dialogue Management in Vector-based Call Routing,” Proc. ACL and COLING, Montreal, pp. 256-262, 1998; and A. N. Pargellis, A. Potamianos, “Cross-Domain Classification using Generalized Domain Acts,” Proc. Sixth Intl. Conf. on Spoken Lang. Proc., Beijing, 3:502-505, 2000., all incorporated herein by reference). However, speech understanding models and algorithms designed for a single task, have little generalization power and are not portable across application domains.

The first step in designing an understanding module for a new task is to identify the set of semantic classes, where each semantic class is a meaning representation, or concept, consisting of a set of words and phrases with similar semantic meaning. Some classes, such as those consisting of lists of names from a lexicon, are easy to specify. Others require a deeper understanding of language structure and the formal relationships (syntax) between words and phrases. A developer must supply this knowledge manually, or develop tools to automatically (or semi-automatically) extract these concepts from annotated corpora with the help of language models (LMs). This can be difficult since it typically requires collecting thousands of annotated sentences, usually an arduous and time-consuming task.

One approach is to automatically extend to a new domain any relevant concepts from other, previously studied tasks. This requires a methodology that compares semantic classes across different domains. It has been demonstrated that semantic classes from a single domain can be semi-automatically extracted from training data using statistical processing techniques (see, M. K. McCandless, J. R. Glass, “Empirical Acquisition of Word and Phrase Classes in the ATIS Domain,” Proc. Of the Third European Conf. on Speech Comm. And Tech., pp. 981-984, Berlin, 1993; A. Gorin, G. Riccardi, J. H. Wright, “How May I Help You?,” Speech Communications, 23:113-127, 1997; K. Arai, J. H. Wright, G. Riccardi, A. L. Gorin, “Grammar Fragment Acquisition using Syntactic and Semantic Clustering,” Proc. Fifth Intl. Conf. on Spoken Lang. Proc., 5:2051-2054, Sydney, 1998; and K. C. Siu, H. M. Meng, “Semi-automatic Acquisition of Domain-Specific Semantic Structures,” Proc. Of the Sixth European Conf. on Speech Comm. And Tech., 5:2039-2042, Budapest, 1999, all incorporated herein by reference.) because semantically similar phrases share similar syntactic environments. (See, for example, Siu, et al., supra.). This raises an interesting question: Can semantically similar phrases be identified across domains? If so, it should be possible to use these semantic groups to extend speech-understanding systems from known domains to a new task. Semantic classes, developed for well-studied domains, could be used for a new domain with little modification.

Accordingly, what is needed in the art is a way to identify the extent to which a semantic class is domain-independent or the extent to which domains are similar relative to a particular semantic class. Similarly, what is needed in the art is a way to determine the degree to which a semantic class may be employable in the context of another domain.

### SUMMARY OF THE INVENTION

To address the above-discussed deficiencies of the prior art, the present invention provides a system for, and method of, measuring a degree of independence of semantic classes in separate domains. In one embodiment, the system includes: (1) a cross-domain distance calculator that estimates a similarity between n-gram contexts for the semantic classes in each of the separate domains to determine domain-dependent relative entropies associated with the semantic classes and (2) a distance summer, associated with the cross-domain distance calculator, that adds the domain-dependent distances over a domain vocabulary to yield the degree of independence of the semantic classes. For purposes of the present invention, an “n-gram” is a generic term encompassing bigrams, trigrams and grams of still higher degree.

As previously described, the design of a dialogue system for a new domain requires semantic classes (concepts) to be identified and defined. This process could be made easier by importing relevant concepts from previously studied domains to the new one.

It is believed that domain-independent semantic classes (concepts) should occur in similar syntactic (lexical) contexts across domains. Therefore, the present invention is directed to a methodology for rank ordering concepts by degree of domain independence. By identifying task-independent versus task-dependent concepts with this metric, a system developer can import data from other domains to fill out the set of task-independent phrases, while focusing efforts on completely specifying the task-dependent categories manually.

A longer-term goal for this metric is to build a descriptive picture of the similarities of different domains by determining which pairs of concepts are most closely related across domains. Such a hierarchical structure would enable one to merge phrase structures from semantically similar classes across domains, creating more comprehensive representations for particular concepts. More powerful language models could be built that those obtained using training data from a single domain.

Accordingly, the present invention introduces two methodologies, based on comparison of semantic classes across domains, for determining which concepts are domain-independent, and which are specific to the new task.

In one embodiment of the present invention, the cross-domain distance calculator estimates the similarity between the n-gram contexts for each of the semantic classes in a lexical environment of an associated domain. This is called “concept-comparison.” In an alternative embodiment, the cross-domain distance calculator estimates the similarity between the n-gram contexts for one of the semantic classes in a lexical environment of a domain other than an associated domain. This is called “concept projection.”

In one embodiment of the present invention, the cross-domain distance calculator employs a Kullback-Liebler distance to determine the domain-dependent relative entropies. Those skilled in the pertinent art will understand, however, that other measures of distance or similarity between two probability distributions may be applied with respect to the present invention without departing from the scope thereof.

In one embodiment of the present invention, the n-gram contexts are manually generated. Alternatively, th n-gram contexts may be automatically generated by any conventional or later-discovered means.

In one embodiment of the present invention, each of the separate domains contains multiple semantic classes, the cross-domain distance calculator and the distance summer operating with respect to each permutation of the semantic classes.

In one embodiment of the present invention, the distance summer adds left and right context-dependent distances to yield the degree of independence.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 is a notional diagram illustrating two variations of semantic class extension as between two domains;

FIG. 2 is a flow diagram of a concept-comparison method for measuring domain independence of semantic classes;

FIG. 3 is a flow diagram of a concept-projection method for measuring domain independence of semantic classes; and

FIG. 4 is a block diagram of a system for measuring domain independence of semantic classes.

### DETAILED DESCRIPTION

Semantic classes are typically constructed manually, using static lexicons to generate lists of related words and phrases. An automatic method of concept generation could be advantageous for new, poorly understood domains. However, for purposes of the present discussion, metrics are validated using sets of predefined, manually generated classes.

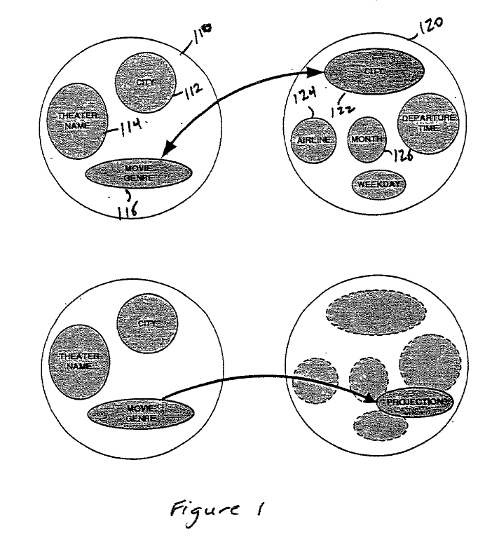

Two different statistical measurements may be employed to estimate the similarity of different domains. FIG. 1 is a notional diagram illustrating two variations of semantic class extension as between two domains. More specifically, FIG. 1 shows a schematic representative of the two metrics for a Movie domain 110 (which encompasses semantic classes such as <CITY> 112, <THEATER NAME> 114 and <GENRE> 116), and a Travel domain 120 (with concepts such as <CITY> 122, <AIRLINE> 124 and <MONTH> 126). Other concepts in the travel information domain 120 shall go undesignated.

The concept-comparison metric, shown at the top of FIG. 1, estimates the similarities for all possible pairs of semantic classes from two different domains. Each concept is evaluated in the lexical environment of its own domain. This method should help a designer identify which concepts could be merged into larger, more comprehensive classes.

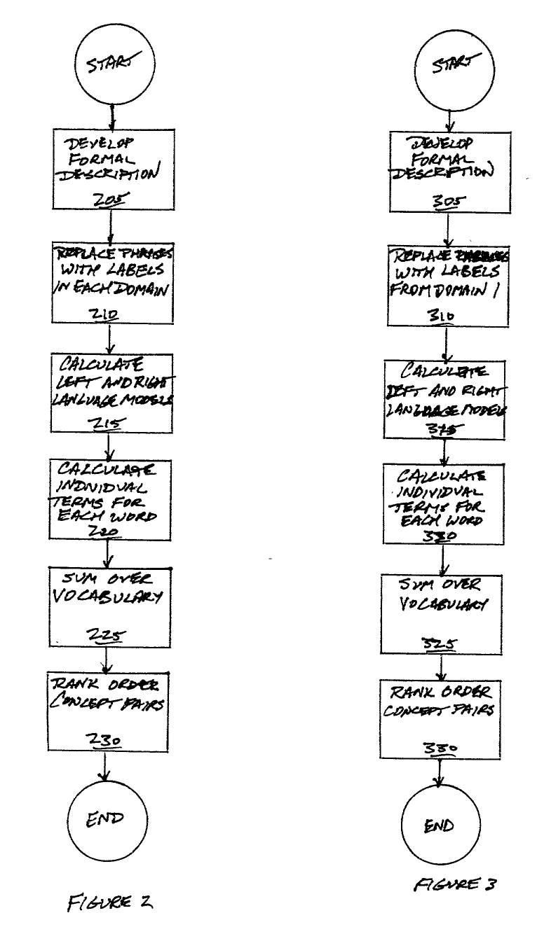

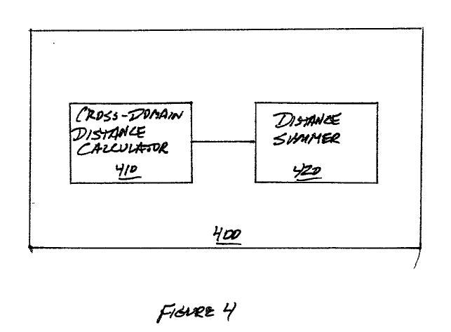

The concept-projection metric is quite similar mathematically to the concept-comparison metric, but it determines the degree of task (in)dependence for a single concept from one domain by comparing how that concept is used in the lexical environments of different domains. Therefore, this method should be useful for identifying the degree of domain-independence for a particular concept. Concepts that are specific to the new domain will not occur in similar syntactic contexts in other domains and will need to be fully specified when designing the speech understanding systems. Concept-comparison and concept-projection will now be described with reference to FIGS. 2 and 3, respectively.

Concept-Comparison

Turning now to FIG. 2, the comparison method (generally designated 200) compares how well a concept from one domain is matched by a second concept in another domain. For example, suppose (top of FIG. 1) it is desired to compare the two concepts, <GENRE> 116={comedies/westerns} from the Movie domain 110 and <CITY> 122={san francisco/newark} from the Travel domain 120. This is done by comparing how the phrases “san francisco” and “newark” are used in the Travel domain 120 with how the phrases “comedies” and “westerns” are used in the Movie domain 110. In other words, how similarly are each of these phrases used in their respective tasks?

A formal description is initially developed (in a step 205) by considering two different domains, dₐ and d_{b}, containing M and N semantic classes (concepts) respectively. The respective sets of concepts are {Cₐ₁, Caₐ₂, . . . , Cₐₘ, . . . C_{aM}} for domain dₐ and {C_{b1}, C_{b2}, . . . , C_{bm}, . . . C_{bN}} for domain d_{b}. These concepts could have been generated either manually or by some automatic means.

Next, the similarity between all pairs of concepts across the two domains 110, 120 is found, resulting in M×N comparisons; two concepts are similar if their respective n-gram contexts are similar. In other words, two concepts Cₐₘ and C_{bn} are compared by finding the distance between the contexts in which the concepts are found. The metric uses a left and right context n-gram language model for concept Cₐₘ in domain dₐ and the parallel n-gram model for concept C_{bm} in domain dₐ to form a probabilistic distance metric.

Since Cₐₘ is the label for the m^{th} concept in domain dₐ, Cₐₘ denotes the set of all words or phrases that are grouped together as the mₜₕ concept dₐ, i.e., all words and phrases that get mapped to concept Cₐₘ. As an example, Cₐₘ=<CITY> and Cₐₘ={san francisco/newark}. Similarly, Wₐₘ denotes any element of the Cₐₘ set, i.e., Wₐₘ ε Cₐₘ.

In order to calculate the cross-domain distance measure for a pair of concepts, all instances of phrases Wₐₘε Cₐₘ are replaced in the training corpus dₐ with the label Cₐₘ (designated by Wₐₘ→Cₐₘ for m=1 . . . M in domain dₐ and W_{bn}→Cₐₘ for n=1 . . . N in domain d_{b}) in a step 210. Then a relative entropy measure, the Kullback-Leibler (KL) distance, is used to estimate the similarity between any two concepts (one from domain dₐ and one from d_{b}) . The KL distance is computed between the n-gram context probability density functions for each concept.

Next, the left and right language models, p^{R} and p^{L}; are calculated in a step 215. The left context-dependent n-gram probability is of the form

$${ρ}_{a}^{L} ( v \vert {C}_{am} ) ,$$

which can be read as “the probability that v is found to the left of any word in class Cₐₘ in domain dₐ (i. e., the ratio of counts of . . . vCₐₘ . . . to counts of . . . Cₐₘ . . . in domain dₐ. Similarly, the right context probability

$$ρ \frac{R}{α} ( v \vert {C}_{am} ) )$$

is the probability that v occurs to the right of class Cₐₘ (equivalent to the traditional n-gram grammar). This calculation takes place in a step 220.

From these probability distributions, KL distances are defined by summing over the vocabulary V for a concept Cₐₘ from domain dₐ and a concept C_{bn} from d_{b} in a step 225. The left KL distance is given as

$$\begin{matrix}{D}_{am , bm}^{L} = D ( {p}_{a}^{L} ( {C}_{am} ) \vert \vert {p}_{b}^{L} ( {C}_{am} ) ) = \\ = {\sum }_{v ∈ V} {p}_{a}^{L} ( v \vert {C}_{am} ) log \frac{{p}_{a}^{L} ( v \vert {C}_{am} )}{{p}_{b}^{L} ( v \vert {C}_{am} )}\end{matrix} \qquad ( 1 )$$

and the right context-dependent KL distances are defined similarly.

The distance d between two concepts, Cₐₘ and C_{bn} is computed as the sum of the left and right context-dependent symmetric KL distances. Specifically, the total symmetric distance between two concepts Cₐₘ and C_{bn} is

$$d ( {C}_{am} , {C}_{am} \vert {d}_{a} , {d}_{b} ) = {D}_{am , bm}^{L} + {D}_{bm , am}^{L} + {D}_{am , bm}^{R} + {D}_{bm , am}^{R}$$

Finally, the concept pairs are rank ordered in a step 230.

The distance between the two concepts Cₐₘ and C_{bn} is a measure of how similar their respective domains' lexical contexts are within which they are used. (See, Siu, et al., supra). Similar concepts should have smaller KL distances. Larger distances indicate a poor match, possibly because one or both concepts are domain-specific. The comparison method enables a comparison of two domains directly as it gives a measure of how many concepts, and which types, are represented in the two domains being compared. KL distances cannot be compared for different pairs of domains, since they have different pair probability functions. So the absolute numbers are not meaningful, although the rank ordering within a pair of domains is.

Concept-Projection

Turning now to FIG. 3, the concept-projection method investigates how well a single concept from one domain is represented in another domain. If the concept for a movie type is <GENRE>116={comedies|westerns}, it is desired to compare how the words “comedies” and “westerns” are used in both domains. In other words, how does the context, or usage, of each concept vary from one task to another? The projection method addresses this question by using the KL distance to estimate the degree of similarity for the same concept when used in the n-gram contexts of two different domains.

As with the comparison method of FIG. 2, the projection technique uses KL distance measures, but the distributions are calculated using the same concept for both domains. Since only a single semantic class is considered at a time for the projection method, the pdfs for both domains are calculated using the same set of words from just one concept, but using the respective LMs for the two domains. A semantic class Cₐₘ in domain dₐ fulfills a similar function as in domain d_{b} if the n-gram contexts of the phrases Wₐₘε Cₐₘ are similar for the two domains.

First, a formal description is developed in a step 305. In the projection formalism, words are replaced (in a step 310) according to the two rules: Wₐₘ→Cₐₘ for both the dₐ and d_{b} domains. Therefore, both domains are parsed (in a step 315) for the same set of words WₐₘεCₐₘ in the “projected” class, Cₐₘ. Following the procedure for the concept-comparison formalism, the left-context dependent KL distance

$${D}_{am , bm}^{L}$$

is defined (in a step 320) as

$$\begin{matrix}{D}_{am , bm}^{L} = D ( {p}_{a}^{L} ( {C}_{am} ) \vert \vert {p}_{b}^{L} ( {C}_{am} ) ) = \\ = {\sum }_{v ∈ V} {p}_{a}^{L} ( v \vert {C}_{am} ) log \frac{{p}_{a}^{L} ( v \vert {C}_{am} )}{{p}_{b}^{L} ( v \vert {C}_{am} )}\end{matrix} \qquad ( 2 )$$

and the total symmetric distance

$$d ( {C}_{am} , {C}_{am} \vert {d}_{a} , {d}_{b} ) = {D}_{am , bm}^{L} + {D}_{bm , am}^{L} + {D}_{am , bm}^{R} + {D}_{bm , am}^{R}$$

measures the similarity of the same concept Cₐₘ in the different lexical environments of the two domains, dₐ and d_{b}. As in FIG. 2, the vocabulary is summed-over in a step 325, and concept pairs are rank ordered in a step 330.

A small KL distance indicates a domain-independent concept that can be useful for many tasks (relative domain independence), since the Cₐₘ concept exists in similar syntactical contexts for both domains. Larger distances indicate concepts that are probably domain-specific and probably do not occur in any context in the second domain. Therefore, projecting a concept across domains should be an effective measure of the similarity of the lexical realization for that concept in two different domains.

In accordance with the above, FIG. 4 presents a block diagram of a system for measuring domain independence of semantic classes. The system, generally designated 400, includes a cross-domain distance calculator 410. The cross-domain distance calculator 410 estimates a similarity between n-gram contexts for the semantic classes in each of the separate domains so that it can determine domain-dependent relative entropies associated with the semantic classes. Associated with the cross-domain distance calculator 410 is a distance summer 420. The distance summer 420 adds the domain-dependent distances over a domain vocabulary to yield the degree of independence of the semantic classes. The distance summer 420 can further rank order concept pairs as necessary. These occur as described above or by other techniques that fall within the broad scope of the present invention.

Evaluation and Application

In order to evaluate these metrics, it was decided to compare manually constructed classes from a number of domains. The metrics should yield a rank-ordered list of the defined semantic classes, from task independent to task dependent. The evaluation was informal, relying on the experimenter's intuition of the task-dependence of the manually derived concepts.

Three domains were studied: the commercially-available “Carmen Sandiego” computer game, an exemplary movie information retrieval service and an exemplary travel reservation system. The corpora were small, on the order of 2500 or fewer sentences. These three domains are compared in Table 1. The set size for each feature is shown; n-grams and trigrams are only included for extant word sequences.

The Carmen domain is a corpus collected from a Wizard of Oz study for children playing the well-known Carmen Sandiego computer game. The vocabulary is limited; sentences are concentrated around a few basic requests and commands. The Movie domain is a collection of open-ended questions from adults but of a limited nature, focusing on movie titles, show times, and names of theaters and cities. At an understanding level, the most challenging domain is Travel. This corpus is similar to the ATIS corpus, composed of natural speech used for making flight, car and hotel reservations. The vocabulary, sentence structures, and tasks are much more diverse than in the other two domains.

As an initial baseline test of the validity of the metrics described herein, the KL distances are calculated for the Travel and Carmen domains using hand-selected semantic classes. A concept was used only if there were at least 15 tokens in that class in the domain's corpus. The n-gram language model was built using the CMU-Cambridge Statistical Language Modeling Toolkit. Witten Bell discounting was applied and out-of-vocabulary words were mapped to the label UNK. The “backwards LM” probabilities

$${p}_{a}^{L} ( v \vert {C}_{am} )$$

for the sequences . . . vCₐₘ . . . were calculated by reversing the word order in the training set.

Table 2 shows the symmetric KL distances from the concept-comparison method for a few representative concepts. The minimum distances are in bold for cases where the difference is less than 4 and more than 15% from the next lowest KL distance and multiple entries within 15% are in bold.

Three of the concepts shown here are shared by both domains, <CITY>, <WANT>, and <YES>. The <CITY>, <WANT>, and <YES> concepts have the expected KL minima, but <CITY>, <GREET>, and <YES> appear to be confused with each other in the Carmen task. This occurs because people frequently used these words by themselves. In addition, children participating in the Carmen task frequently prefaced a <WANT> query with the words “hello” or “yes,” so that <GREET> and <YES> were used interchangeably. The <CARDINAL> (numbers) and <MONTH> concepts are specific to Travel and they have KL distances above 5 for all concepts in the Carmen domain. The <W.DAY> category has some similarity to the four Carmen classes because people frequently said single-word sentences such as: “hello,” “yes,” “Monday” or “Boston.”

Table 3 shows the KL distances when the concepts in the Travel domain are projected into the other two domains. Carmen and Movie. In this case, each domain's corpus is first parsed only for the words Wₐₘ that are mapped to the Cₐₘ concept being projected. Then the right and left n-gram LMs for the two domains are calculated. The results show that the ranking is the same for both domains for the three highlighted concepts: <WANT>, <YES>, <CITY>.

Note that for the Travel <=> Carmen comparisons, the projected distances (Table 3) are almost the same as the compared distances (Table 2) for these three highlighted classes. This suggests these concepts are domain independent and could be used as prior knowledge to bootstrap the automatic generation of semantic classes in new domains (see, Arai, et al., supra). The most common phrases in these three classes are shown for each domain in Table 4 (the hyphens indicate no other phrases commonly occurred). The <WANT> concept is the most domain-independent since people ask for things in a similar way. The <CITY> class is composed of different sets of cities, but they are encountered in similar lexical contexts so the KL distances are small. The sets of phrases in the respective <YES> classes are similar, but they also share a similarity (see Table 2, above) to members of a semantically different class, <GREET>. The small KL distances between these two classes indicates there are some concepts that are semantically quite different, yet tend to be used similarly by people in natural speech. Therefore, the comparison and projection methodologies also identify similarities between groups of phrases based on how they are used by people in natural speech, and not according to their definitions in standard lexicons.

Although the present invention has been described in detail, those skilled in the art should understand that they can make various changes, substitutions and alterations herein without departing from the spirit and scope of the invention in its broadest form.

What is claimed is:

1. A system for measuring a degree of independence of semantic classes in separate domains, comprising:
a cross-domain distance calculator that estimates a similarity between n-gram contexts for said semantic classes in each of said separate domains to determine domain-dependent relative entropies associated with said semantic classes; and
a distance summer, associated with said cross-domain distance calculator, that adds said domain-dependent distances over a domain vocabulary to yield said degree of independence of said semantic classes.

2. The system as recited in claim 1 wherein said cross-domain distance calculator estimates said similarity between said n-gram contexts for each of said semantic classes in a lexical environment of an associated domain.

3. The system as recited in claim 1 wherein said cross-domain distance calculator estimates said similarity between said n-gram contexts for one of said semantic classes in a lexical environment of a domain other than an associated domain.

4. The system as recited in claim 1 wherein said cross-domain distance calculator employs a Kullback-Liebler distance to determine said domain-dependent relative entropies.

5. The system as recited in claim 1 wherein said n-gram contexts are generated manually or automatically.

6. The system as recited in claim 1 wherein each of said separate domains contains multiple semantic classes, said cross-domain distance calculator and said distance summer operating with respect to each permutation of said semantic classes.

7. The system as recited in claim 1 wherein said distance summer adds left and right context-dependent distances to yield said degree of independence.

8. A method of measuring a degree of independence of semantic classes in separate domains, comprising:
estimating a similarity between n-gram contexts for said semantic classes in each of said separate domains to determine domain-dependent relative entropies associated with said semantic classes; and
adding said domain-dependent distances over a domain vocabulary to yield said degree of independence of said semantic classes.

9. The method as recited in claim 8 wherein said estimating comprises estimating said similarity between said n-gram contexts for each of said semantic classes in a lexical environment of an associated domain.

10. The method as recited in claim 8 wherein said estimating comprises estimating said similarity between said n-gram contexts for one of said semantic classes in a lexical environment of a domain other than an associated domain.

11. The method as recited in claim 8 wherein said estimating comprises employing a Kullback-Liebler distance to determine said domain-dependent relative entropies.

12. The method as recited in claim 8 wherein said n-gram contexts are generated manually or automatically.

13. The method as recited in claim 8 wherein each of said separate domains contains multiple semantic classes, said estimating and said adding carried out with respect to each permutation of said semantic classes.

14. The method as recited in claim 8 wherein said adding comprises adding left and right context-dependent distances to yield said degree of independence.

15. A method of porting a semantic class from a first domain into a second domain, comprising:
measuring a degree of independence of said semantic class, said measuring including:
estimating a similarity between n-gram contexts for said semantic class in said first domain and said second domain to determine a domain-dependent relative entropy associated with said semantic class, and
adding said domain-dependent distances over a domain vocabulary to yield said degree of independence of said semantic classes; and
employing said degree of independence to determine whether said semantic class is properly portable into said second domain.

16. The method as recited in claim 15 wherein said estimating comprises estimating said similarity between said n-gram contexts for said semantic class in a lexical environment of said first domain.

17. The method as recited in claim 15 wherein said estimating comprises estimating said similarity between said n-gram contexts for said semantic class in a lexical environment of said second domain.

18. The method as recited in claim 15 wherein said estimating comprises employing a Kullback-Liebler distance to determine said domain-dependent relative entropies.

19. The method as recited in claim 15 wherein said n-gram contexts are generated manually or automatically.

20. The method as recited in claim 15 wherein said first and second domains each contain multiple semantic classes, said estimating and said adding carried out with respect to each permutation of said semantic class.

21. The method as recited in claim 15 wherein said adding comprises adding left and right context-dependent distances to yield said degree of independence.
